(19) United States
(12) Patent Application Publication
(10) Pub. No.: US 2007/0143202 A1
(43) Pub. Date: Jun. 21, 2007

(54) Method for procuring parts

(75) Inventor: John M. Spangler, Peoria, IL (US)

Correspondence Address: CATERPILLAR/FINNEGAN, HENDERSON, L.L.P., 901 New York Avenue, NW, WASHINGTON, DC, 20001-4413, US

(73) Assignee: CATERPILLAR INC.

(21) Appl. No.: 11/305,161

(22) Filed: Dec. 19, 2005

(51) Int. Cl. G06Q 40/00

(52) U.S. Cl. 705/37

(57) ABSTRACT

A method is provided for requesting a quotation for manipulating at least one part. The method includes establishing at least one request for quotation and sending the at least one request to at least one supplier. The method also includes receiving a price from the at least one supplier for at least one manipulated part and receiving information regarding a process configured to manipulate the at least one part. The method further includes estimating a cost of manipulating the at least one part as a function of the received information.

### TECHNICAL FIELD

The present disclosure relates to a method for procuring parts and, more particularly, to a method for requesting a quotation for procuring parts.

### BACKGROUND

Finished products, such as, for example work machines, are typically produced by one or more processes which manipulate one or more parts therein. Such processes often include a fabrication process, a painting process, an assembly process, and/or other material handling processes. Each process is usually configured to manipulate various quantities and/or types of parts desirous or necessary to produce one or more of the finished products. The degree of difference in quantities and/or types of parts may vary significantly and a particular process may not be suitable to manipulate all of the different parts. That is, a particular process may require a long lead time, may utilize significant amounts of resources, may be complicated to operate, may be designed for a particular size or quantity of parts, and/or may otherwise incur a higher than desired cost associated with manipulating the different parts and thus the production of the finished products.

Companies often out-source the manipulation of certain parts to suppliers in an attempt to procure the manipulated parts at a more desirable cost than if produced in-house or to reallocate in-house resources to manipulate other parts. Companies typically request a quotation from each of one or more potential suppliers. Companies typically receive a plurality of quotations, compare the received quotations based on company experience, judgment, non-uniform decisions, and/or other unstructured criteria, and select one or more of the potential suppliers to provide manipulated parts to the company. Often companies receive one or more quotations that inaccurately represent a potential supplier's abilities, effectiveness, and/or a actual cost of manipulating parts. Additionally, suppliers are often unreliable, often manipulate parts to less than desired specifications, often inaccurately assess process capabilities, and/or otherwise adversely affect the procurement of out-sourced parts. Furthermore, quantities, lead times, and/or other factors affecting the scope, e.g., quantity or delivery schedules, of manipulated parts typically fluctuate before and during manipulation of the parts. These adverse effects often increase the cost associated with procuring the parts and thus producing the finished product.

U.S. Patent Application Publication No. 2002/0023060 (“the '060 application”) filed by Cooney et al. discloses a purchasing process configured to develop a potential cost for a part. Specifically, the '060 application discloses a system to evaluate and establish the best manufacturing procedures for producing a part, such as, designing, labor, capital expenses, manufacturing processes or machines. A predicted cost for producing the part is determined as a function of the best manufacturing procedures necessary to produce a state-of-the art part. Invitations to bid are sent to potential suppliers and received bids are compared with the predicted cost to evaluate the quality of the supplier.

Although the system of the '060 application may request quotations from potential suppliers and compare an associated cost with a predicted cost, it may not receive information regarding a process a supplier might use to manipulate the parts. Additionally, the received quotations of the '060 application may require additional evaluation and/or judgment decisions to compare the quotations with each other on a comparable cost basis. Also, the system of the '060 application may be unreliable and/or require complex and experience based decisions to establish the predicted cost using the best manufacturing procedures and thus to procure out-sourced parts. Furthermore, the best manufacturing procedures may not be necessary to manipulate the parts and as such, the system of the '060 application may procure parts at a higher than desired quality and thus a higher than desired price.

The present disclosure is directed to overcoming one or more of the shortcomings set forth above.

### SUMMARY OF THE INVENTION

In one aspect, the present disclosure is directed to a method for requesting a quotation for manipulating at least one part. The method includes establishing at least one request for quotation and sending the at least one request to at least one supplier. The method also includes receiving a price from the at least one supplier for at least one manipulated part and receiving information regarding a process configured to manipulate the at least one part. The method further includes estimating a cost of manipulating the at least one part as a function of the received information.

In another aspect, the present disclosure is directed to a request for quotation. The request for quotation includes a plurality of requests for information regarding a process. The process is configured to affect a manipulation of at least one part. The plurality of requests for information configured to induce a supplier to provide information regarding the capability of the process to manipulate the at least one part. The information enables an entity to estimate a cost to manipulate the at least one part. The request for quotation also includes at least one request for a price of the at least one part.

In yet another aspect, the present disclosure is directed to a method for procuring at least one part. The method includes identifying a plurality of parts desired to be manipulated and requesting quotations from a plurality of suppliers. The method also includes receiving a quotation from each of the plurality of suppliers. Each of the quotations includes a price and information regarding a process. The method further includes determining first and second subsets of prices as a function of the received information. The first subset of prices includes prices determined as undesirable prices and the second subset includes prices determined as desirable prices. The method still further includes comparing each of the prices of the second subset of prices with one another and determining the lowest price.

### BRIEF DESCRIPTION OF THE DRAWINGS

FIG. 1 is a schematic block diagram of an exemplary method for procuring parts in accordance with the present disclosure; and

FIG. 2 is a schematic block diagram of an exemplary method for requesting a quotation in accordance with the method of FIG. 1.

### DETAILED DESCRIPTION

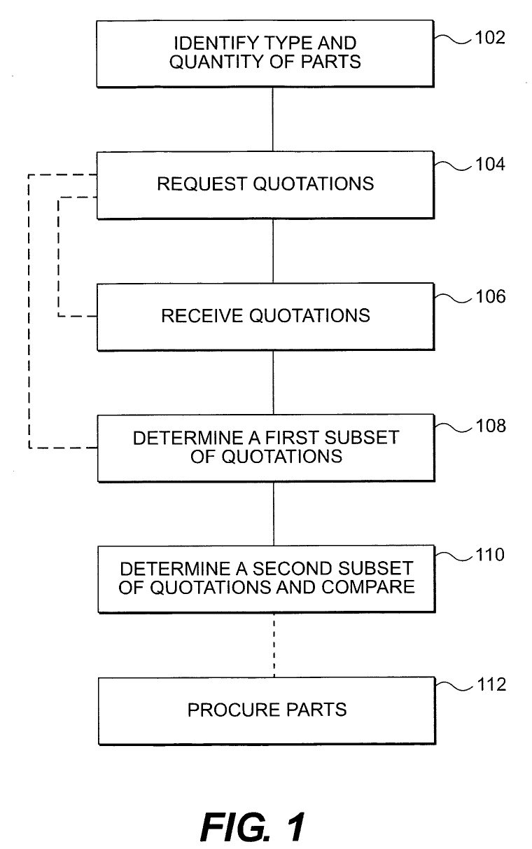

FIG. 1 illustrates a method 100 configured to procure parts. Specifically method 100 may determine one or more suppliers from which parts may be procured. Method 100 may include identifying a type and a quantity of parts to be procured, step 102. Method 100 may also include requesting quotations from potential suppliers, step 104, and receiving quotations from the potential suppliers, step 106. Method 100 may also include determining a first subset of quotations, step 108. Method 100 may also include determining a second subset of quotations and comparing each quotation of the second subset with one another, step 110. Method 100 may further include procuring parts from one or more suppliers, step 112.

Step 102 may be configured to identify a type and/or quantity of parts. Specifically, step 102 may establish one or more parts desired to be procured from one or more potential suppliers. For example, step 102 may include an entity accessing one or more databases indicative of one or more parts that may be desired and/or required to produce a desired quantity of finished products, such as, for example, bills of materials, purchase orders, delivery schedules for finished products, and/or any other suitable database known in the art. It is contemplated that the parts may include any type, e.g., different sizes, shapes, materials, weights, or other properties, and/or quantity, e.g., different amounts of one or more types of parts. It is also contemplated that the parts may be manipulated by the potential suppliers within any existing process, any existing process with proposed modifications, and/or any conceptual process such as, for example, a refining process, a fabrication process, a manufacturing process, a coating process, an assembly process, a packaging process, a warehousing process, any process known in the art, or a combination of one or more such processes. It is further contemplated that the processes proposed to be utilized by potential suppliers may be configured to affect any type of manipulation such as, for example, tooling, coating, geometry shaping, heat treating, packaging, transporting, arranging, refining, assembling, and/or any other type of manipulation.

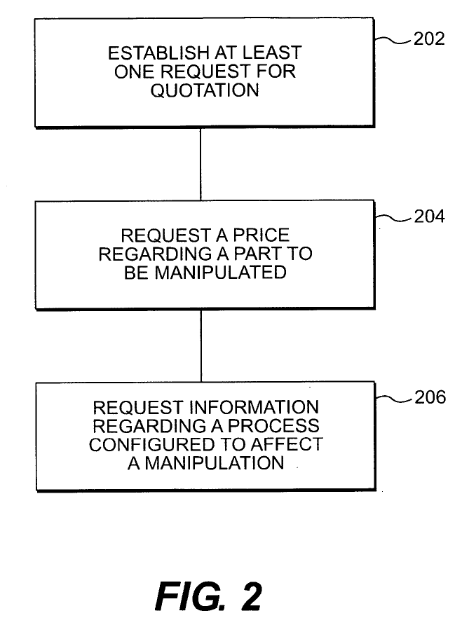

Step 104 may be configured to request quotations. Specifically, step 104 may include requesting a quotation from each of the potential suppliers and may be configured to solicit, via a method 200, a price comparable with other received prices with respect to a manipulation cost basis from each of the potential suppliers. Step 104, and in particular method 200 will be further described below with reference to FIG. 2.

Step 106 may be configured to receive quotations. Specifically, step 106 may include receiving quotations from one or more of the potential suppliers. For example, a potential supplier may submit an electronic and/or hardcopy response to the request for quotation. Additionally, each received quotation may include a price and/or information regarding a process proposed to be utilized by a potential supplier to manipulate the parts. It is contemplated that quotations may not be received from each of the potential suppliers and/or one or more received quotations may be determined to be incomplete, e.g., a potential supplier provided incomplete and/or no data in response to one or more requests for price and/or information. It is also contemplated that method 100 may return to step 104 to, for example, establish a new request for quotation and/or submit the established request for quotation to one or more different potential suppliers.

Step 108 may be configured to determine a first subset of quotations. Specifically, step 108 may include determining one or more of the received quotations to be undesirable, e.g., determined to be indicative of an unsatisfactory supplier, and establishing the first subset as those quotations determined to be undesirable. Step 108 may be configured to compare a received price with received information to determine the desirability of the received price. For example, the received information may be evaluated to determine a cost and/or cost range that a potential supplier might incur by utilizing a process to manipulate the parts. The received price may be compared with the determined cost or cost range. A quotation may be determined to be within the first subset of quotations if the received price is not substantially equal to, or within a predetermined deviation of, the determined cost or if the received price is not within the determined cost range. For example, a received price that is outside the determined cost or cost range may be indicative of an unsatisfactory supplier because the supplier may not appreciate the current market for such parts, may not understand a process proposed to be utilized to manipulate such parts, may go out of business, may be price gouging, and/or may be indicative of other criteria considered unsatisfactory. Additionally, step 108 may be configured to compare received prices with respect to one or more quantities with one another. For example, received prices for different quantities of the same part may be compared with the determined cost or cost range to determine which, if any, of the received prices are substantially equal to or within a predetermined deviation of the determined cost or if the received price is within the determined cost range. It is contemplated that the first subset of quotations may include zero or more quotations. It is also contemplated that all of the received quotations may be determined to be within the first subset of quotations. Method 100 may return to step 104 and request quotations from one or more different suppliers and/or modify the request for quotation as a function of the determination of the first subset of quotations and/or as a function of any other criteria, such as, for example, determining that one or more of the processes may be designed for particular quantities and/or types of parts. It is further contemplated that any decision process, algorithm, and/or other determination method known in the art may be performed to estimate a cost to manipulate the parts and thus to determine the first subset of quotations.

Step 110 may be configured to determine a second subset of quotations. Specifically, step 110 may include determining one or more of the received quotations not determined to be within the first subset to be within the second subset. Alternatively, step 110 may determine the second subset of quotations by determining one or more received quotations to be desirable, e.g., determined to be indicative of a satisfactory supplier. For example and similar to determining the first subset, received prices may be compared with a determined cost or cost range. A received quotation may be determined to be within the second subset if a received price is substantially equal to or within a predetermined deviation of the determined cost or if the received price is within the determined cost range. As such, the second subset of quotations may be related on a comparable cost basis and may be related with one another without qualification or judgment regarding the desirability and/or accuracy of a received price. It is contemplated that the second subset of quotations may include zero or more quotations, and, for example, may include all of the received quotations. It is also contemplated that any decision process, algorithm, and/or other determination method known in the art may be performed to estimate a cost to manipulate the parts and thus to determine the second subset of quotations.

Step 112 may be configured to procure parts. Specifically, step 112 may include procuring parts from one or more potential suppliers associated with a quotation determined to be within the second subset of quotations. It is noted that the second subset may include no quotations and, as such, it is contemplated that no parts may be procured from the potential suppliers in step 112. It is contemplated that no parts may be procured from the potential suppliers regardless of the quantity of quotations within the second subset. It is also contemplated that parts may be procured in any suitable manner known in the art, such as, for example, via a purchase order.

FIG. 2 illustrates a method 200 configured to request quotations from potential suppliers. Method 200 may include establishing at least one request for quotation, step 202. Method 200 may also include requesting a price regarding a part to be manipulated, step 204. Method 200 may further include requesting information regarding a process configured to manipulate a part, step 206.

Step 202 may be configured to establish at least one request for quotation. For example, the request for quotation may include a printed document, an interactive electronic database, an interactive computer executable program displaying a series of screens in a graphical user interface, and/or any other tangible request, communicable to an entity, known in the art. Specifically, step 202 may include establishing an electronic or hardcopy series of forms, questions, explanations, specifications, drawings, instructions, correspondences, sample forms, and/or any other requests known in the art. For example, the request for quotation may include information regarding the parts, such as, for example, lists and/or descriptions of types and/or quantities of parts, specifications or requirements regarding a desired manipulation of parts, information regarding subsequent manipulations and/or uses of parts, and/or any other data known in the art. It is contemplated that a request for quotation may include any quantity of requests and that a potential supplier may, in response to such requests, answer, complete, and/or respond in any suitable manner known in the art. It is also contemplated that the request for quotation may be communicated to and/or from a potential supplier via any suitable manner known in the art, such as, for example, postal mail, electronic mail, and/or login access via an Internet website. It is further contemplated that the quantity of requests for quotations may or may not be equal to a quantity of potential suppliers.

Step 204 may be configured to request a price regarding a part to be manipulated. Specifically, step 204 may include one or more requests configured to induce a potential supplier to provide a monetary price per part as an offer to sell a given quantity of manipulated parts at the monetary price. For example a request for price may induce a potential supplier to provide a price of $200 per part for a quantity of parts less than 100 parts. It is contemplated that step 204 may be configured to request a plurality of prices of a part to be manipulated, each of the plurality of price requests associated with either a different quantity or a different type of manipulated parts.

Step 206 may be configured to request information regarding a process a potential supplier might utilize to affect a manipulation of one or more parts. Specifically, step 206 may include one or more requests configured to induce a potential supplier to provide information regarding a process configured to manipulate the parts. The information may include any known information indicative of and/or related to the process, such as, for example, a layout of the process, types of equipment capable of partially or completely manipulating one or more parts, sizes or capacities of equipment, labor associated with the process, utilities necessary to operate the process, process capacity, process cycle times, process capability to affect manipulation of given quantities of parts per unit time, process lead times, and/or any other information known in the art regarding a process. It is contemplated that a process may include any material handling process known in the art within which one or more parts may be manipulated and may include, for example, any type of equipment, e.g., machinery, arranged within one or more stages, and/or resources which may be consumed within the process, e.g., within the equipment and/or within the stages, to affect the manipulation of the parts. It is also contemplated that a process may be configured to affect any type of manipulation such as, for example, tooling, coating, geometry shaping, heat treating, packaging, refining, transporting, arranging, assembling, and/or any other type of manipulation know in the art. It is further contemplated that the request for quotation may additionally include requests for any type of information desired to be received from a supplier, such as, for example, process location information, delivery information, prior business relationships, and/or any other information known in the art.

### INDUSTRIAL APPLICABILITY

The disclosed method may be applicable to any procurement of parts. The disclosed method may be configured to request and receive quotations from one or more suppliers on a comparable cost basis. The operation of methods 100 and 200 are explained below with reference to a company procuring painted parts for explanatory purposes only and it is noted that the explanation below is applicable to any entity procuring any parts.

A company may desire to produce a given quantity of finished products, e.g., a given quantity of work machines. The company may out-source the manipulation, e.g., painting, of one or more particular parts, e.g., frames, configured as components of one or more of the work machines. As such, the company may request quotations from potential suppliers to identify and select one or more of the potential suppliers from which the company may procure the painted frames.

The company may determine the type and quantity of frames to be painted (step 102). For example, the company may desire to out-source the painting of all frames that are desired to be painted black to produce the desired quantity of work machines. As such, the company may reduce or eliminate the need to paint black frames in-house and thus, may reduce costs associated with producing the work machines by, for example, reducing or eliminating the cost of changing paint colors within an in-house painting process. It is contemplated that a company may be motivated to out-source a manipulation of parts as a function of any suitable criteria, such as, for example, reducing labor or utility costs, performing critical manipulations in-house and out-sourcing less than critical manipulations, and/or improving production rates of work machines.

The company may establish one or more requests for quotation to procure the black frames (step 104). Specifically, a request for quotation may include descriptions and other data indicative of the type and quantity of the black frames, one or more requests for prices to procure different quantities of black frames, one or more specifications regarding the black frames, and/or one or more requests for information regarding a painting process that a supplier might utilize to paint the black frames. For example, to produce a given quantity of work machines per week, the company may desire 100 black frames per week. As such, the request for quotation may include requests for the price to supply 10, 25, 50, and/or 100 black frames per week. Additionally, the request for quotation may include requests regarding each potential supplier's painting process, such as, for example, the layout, the quantity of personnel working on any given shift, the type and size of a painting booth, a type and size of a curing oven, and/or any other information regarding a painting process known in the art.

The company may submit the requests for quotation to potential suppliers and receive one or more quotations therefrom (step 106). The received quotations may include responses, e.g., answers to questions, to one or more of the requests set forth in the request for quotation. The company may determine that one or more of the received quotations are incomplete by, for example, only receiving responses to requests for prices and not receiving responses to requests for information regarding a process. As such, the company may, with respect to the incomplete received quotation, resubmit a request for quotation to the associated potential supplier, may determine the received quotation to be within the first subset of quotations, and/or may disregard the quotation. It is contemplated that the company may receive only incomplete quotations and, as such, may, for example, establish a new request for quotation and/or submit the established request for quotation to one or more different potential suppliers.

The company may determine a first subset of quotations by comparing a price and associated information regarding a potential supplier's e.g., first supplier's, painting process (step 108). For example, the company may receive from a first supplier a price of $200 per frame for 100 frames per week and also receive information regarding the size and necessary utility and labor consumption of a painting booth of the first supplier's painting process. The company may evaluate the received price and information and might estimate that to paint 100 frames per week, the first supplier may need to operate the process for three shifts per day, at a cost of consumed utilities and labor that exceeds $200 per frame. The company may determine that the quotation received from the first supplier may be undesirable, e.g., the first supplier may not be capable of providing 100 frames per week at a price of $200 per frame and achieve a profit. As such, the company may determine the quotation received from the first supplier to be within the first subset of quotations because the below cost price may be an indication of supplier inexperience, future price increases, a likelihood of insufficient delivery, lack of supplier knowledge regarding the process, and/or indicative of other supplier qualities which the company may determine as indicative of an unsatisfactory supplier. The company may similarly evaluate each of the received quotations and thus determine the first subset of quotations.

Additionally, the company may determine the first subset by comparing a plurality of received prices, e.g., prices received for different quantities of frames, from a single supplier with one another. For example, the company may receive from the first supplier prices of $200 for each of 10, 25, 50, and 100 quantities of black frames per week. As noted above, the company may determine that the first supplier's cost of painting 100 frames per week may exceed $200 per frame. Similarly, the company may also estimate the first supplier's costs associated with providing 10, 25, and 50 black frames per week and determine that the first supplier may not be capable of painting such quantities of frames at a price of $200 per frame and achieve a profit. As such, the company may determine the quotation received from the first supplier to be within the first subset of quotations because such pricing may be indicative of an unsatisfactory supplier for similar reasons as noted above. Additionally, the company may determine the quotation received from the first supplier to be within the first subset because receiving the same price for different quantities may be an indication that first supplier may be an unsatisfactory supplier with respect to changes in scope, e.g., increased or decreased quantities of black frames desired to be procured.

It is contemplated that the company may determine that the first supplier may be capable of supplying one or more quantities at the respective received prices but not capable of supplying all of the quantities at the respective received prices. As such, the company may determine the first supplier to be a satisfactory supplier of black frames at certain quantities. It is also contemplated that the company may establish a new request for quotation and/or resubmit request for quotations to one or more potential suppliers indicative of the different quantities. It is further contemplated that the company may identify quantities as a function of the received prices which may be better coordinated to processes proposed to be utilized by the potential suppliers, e.g., the requested quantities may be too small or too large for efficient manipulation within the processes proposed to be utilized by the potential suppliers. For example, the company may identify that no process proposed to be utilized by a supplier is capable of producing the required quantities as desired. As such, the company may establish a new request for quotation, e.g., a request for quotation for a conceptual process rather than an existing process and/or resubmit the requests for quotations to different suppliers. It is noted that the analysis described above with respect to different quantities of parts is applicable to different types of parts.

The company may determine a second subset of quotations to include received quotations that were not determined to be within the first subset of quotations (step 110). For example, the company may receive five quotations from potential suppliers and may determine two of the received quotations to be within the first subset. As such, the company may determine the remaining three received quotations to be within the second subset.

Alternatively, the company may determine the second subset by comparing a price and associated information regarding a painting process received from a potential supplier, e.g., second supplier. For example, the company may receive a price of $500 per frame for 100 frames per week and receive information regarding the size and necessary utility and labor consumption of a painting booth. The company may evaluate the received price and information and might determine that to paint 100 frames per week, second supplier may need to operate the process for three shifts per day, at a cost of consumed utilities and labor below $500 per frame. The company may determine that the quotation received from a second supplier may be desirable, e.g., the second supplier may be capable of providing 100 frames per week at a price of $500 per frame and achieve a profit. As such, the company may determine the price received from the second supplier to be an indication of a satisfactory supplier.

The quotations within the second subset may be related to one another on a comparable cost basis. Specifically, each potential supplier associated with a second subset quotation may be capable of supplying the desired quantity and type of part at the quoted price. As such, the respective prices may be compared with one another as a function of manipulation costs without additional judgment, price augmentation and/or other price assessment. For example, painting processes may be individually designed to efficiently paint parts as a function of, for example, size, quantity, or type. Specifically, a cost associated with painting large parts, e.g., frames, may be substantially dependent upon the painting process proposed to be utilized to paint the frames. A painting process designed to accommodate small parts, e.g., hinges, may include a painting booth or other equipment having a manipulation envelope that may allow simultaneous manipulation of several hinges but only allow manipulation of a single frame. Accordingly, the labor or utility costs associated with operating the painting booth may be substantially the same for each manipulation. Because, the process may be designed to efficiently manipulate small parts the manipulation costs may be distributed across the several hinges establishing a lower cost per hinge than a single frame. Similarly, a painting process may be designed to accommodate large parts, e.g., frames, and may include a painting booth or other equipment having a manipulation envelope that may allow simultaneous manipulation of several frames. Accordingly, such a painting process may be designed to efficiently paint large parts and the costs may be distributed across the several frames establishing a lower cost per frame than per a hinge. It is noted that the example set forth above with respect to a painting process set forth above is applicable to any process.

By receiving information regarding potential supplier painting processes, the company may determine that each of the potential suppliers associated with a quotation within the second subset may be capable of manipulating and providing the painted frames as desired. As such, the respective prices received from each of the potential suppliers within the second subset may be related on a comparable cost basis. That is, each of the prices associated with quotations within the second subset may be compared with one another without adjusting the price to account for past supplier experience, price elimination because the company considers the price too low to be realistic, and/or without additional price qualifications. It is noted that a potential supplier, e.g., the second supplier, that submits the lowest price may be capable of painting the desired parts at the submitted price because the process proposed to be utilized by the second supplier may be suited for the type, size, or quantity of the frames, may efficiently operate a painting process, and/or second supplier may be willing to accept the lowest profit per part as compared to other suppliers. It is contemplated that potential suppliers may submit prices based on any criteria, such as, for example, profit margin, scheduling, demands from other purchasers, supplier schedules, and that the company may select one or more suppliers from which to procure parts based on any criteria such as, for example, lowest price, production schedules, supplier location, delivery costs.

Because the method of procuring parts may include receiving information regarding a process a potential supplier may utilize to manipulate parts, price quotations may be compared on a comparable cost basis. Accordingly, further judgments or decisions based on experience may not be necessary to compare price quotations. Additionally, confirming the desirability of a price as a function of the process a potential supplier might utilize to manipulate parts may allow an entity to determine the likelihood and feasibility of the potential supplier to provide the desired quantity of parts according to the desired manipulation specifications.

It will be apparent to those skilled in the art that various modifications and variations can be made to the disclosed method of procuring parts. Other embodiments will be apparent to those skilled in the art from consideration of the specification and practice of the disclosed method. It is intended that the specification and examples be considered as exemplary only, with a true scope being indicated by the following claims and their equivalents.

What is claimed is:

1. A method for requesting a quotation for manipulating at least one part, the method comprising:
establishing at least one request for quotation;
sending the at least one request to at least one supplier;
receiving a price from the at least one supplier for at least one manipulated part;
receiving information regarding a process configured to manipulate the at least one part; and
estimating a cost of manipulating the at least one part as a function of the received information.

2. The method of claim 1, wherein the at least one supplier is a plurality of suppliers, the method further comprising:
receiving a price from each of the plurality of suppliers;
receiving information regarding a process configured to manipulate the at least one part from each of the plurality of suppliers;
estimating a plurality of costs of manipulating the at least one part for each of the plurality of suppliers as a function of the respective received information;
establishing a plurality of cost ranges of manipulating the at least one part associated with each estimated cost; and
establishing a first subset of prices, each price of the first subset outside a respective estimated cost range of manipulating the at least one part.

3. The method of claim 2, further including:
establishing a second subset of prices, each price of the second subset being within a respective estimated cost range of manipulated the at least one part; and
comparing the prices of the second subset with one another to determine the lowest one of the prices of the second subset.

4. The method of claim 1, wherein the received information includes information indicative of process layout, process equipment, process labor, process equipment capacity, or process parameters.

5. The method of claim 1, wherein the received information includes information indicative of process cycle times, process lead times, or process capacity.

6. The method of claim 1, wherein the received information includes information indicative of the cycle times necessary to manipulate different quantities of the at least one part.

7. The method of claim 1, wherein the at least one part is a plurality of parts including at least two different types of parts.

8. A request for a quotation of at least one part comprising:
a plurality of requests for information regarding a process, the process being configured to affect a manipulation of at least one part, the plurality of requests for information configured to induce a supplier to provide information regarding the capability of the process to manipulate the at least one part, the information enabling an entity to estimate a cost to manipulate the at least one part; and
at least one request for a price of the at least one part.

9. The request of claim 8, wherein the plurality of requests for information includes at least one request for a layout of the process.

10. The request of claim 8, wherein:
the process includes at least one machine configured to affect a manipulation on the at least part; and
the plurality of requests for information includes:
a first request for a type of the at least one machine, and
a second request for a capacity of the at least one machine.

11. The request of claim 8, wherein the at least one part is a plurality of parts, further including:
a first request for a price per part of a first quantity of parts; and
at least a second request for a price per part of a second quantity of parts, the second quantity being different than the first quantity.

12. The request of claim 8, wherein the at least one part is a plurality of parts and the plurality of parts includes at least one part of a first type and at least one part of a second type, the second type being different than the first type, further including:
a first request for a price per part of the plurality of parts;
a second request for a price per part of the plurality of parts if the plurality of parts only included parts of the first type.

13. The request of claim 12, wherein the first type includes parts of a first size and the second type includes parts of a second size, the second size being larger than the first size.

14. The request of claim 8, wherein:
the at least one part includes a plurality of parts; and
the plurality of requests for information includes a request for the quantity of parts the process is configured to affect manipulation of within a first time period.

15. A method for procuring at least one part comprising:
identifying a plurality of parts desired to be manipulated;
requesting quotations from a plurality of suppliers;
receiving a quotation from each of the plurality of suppliers, each of the quotations including a price and information regarding a process;
determining first and second subsets of prices as a function of the received information, the first subset of prices including prices determined as undesirable prices and the second subset including prices determined as desirable prices; and
comparing each of the prices of the second subset of prices with one another and determining the lowest price.

16. The method of claim 15, further including identifying the supplier associated with the determined lowest price and procuring at least one part from the identified supplier.

17. The method of claim 15, wherein the prices of the first subset of prices are determined as undesirable as a function of the received information regarding the process.

18. The method of claim 17, wherein received information regarding the process includes at least one of a process layout, a type of a process machine, or a size of a process machine.

19. The method of claim 15, wherein:
the received price is a price per part for a first quantity of parts; and
the received information regarding the process includes at least a price per part for a second quantity of parts, the second quantity being different than the first quantity.

20. The method of claim 19, wherein the plurality of parts includes at least one part of a first type and at least one part of a second type and the received information regarding the process includes a price per part for the at least one part of the first type.
